(19) United States
(12) Patent Application Publication
(10) Pub. No.: US 2014/0237270 A1
(43) Pub. Date: Aug. 21, 2014

(54) POWER SUPPLY CONTROL APPARATUS, POWER SUPPLY CONTROL SYSTEM AND POWER SUPPLY CONTROL METHOD

(71) Applicant: Kenta Nakao, Tokyo (JP)

(72) Inventor: Kenta Nakao, Tokyo (JP)

(73) Assignee: RICOH COMPANY, LTD., Tokyo (JP)

(21) Appl. No.: 14/159,694

(22) Filed: Jan. 21, 2014

(30) Foreign Application Priority Data
Feb. 15, 2013 (JP) 2013-027729

(51) Int. Cl. G06F 1/26

(52) U.S. Cl. CPC G06F 1/266
USPC 713/300

(57) ABSTRACT

A power supply control apparatus is disclosed. The power supply control apparatus includes a positional-information-obtaining unit configured to obtain positional information of a communication terminal; a process-information-obtaining unit configured to obtain process information requested by a user of the communication terminal; a distance-determination unit configured to, based on positional information of a processing apparatus that processes the process information obtained by the process-information-obtaining unit and the positional information of the communication terminal obtained by the positional-information-obtaining unit, calculate a distance between the processing apparatus and the communication terminal; and a power-supply-control unit configured to control a power supply of the processing apparatus based on the distance calculated by the distance-determination unit.

### BACKGROUND OF THE INVENTION

1. Field of the Invention

The disclosures herein generally relate to a power supply control apparatus, a power supply control system and a power supply control method.

2. Description of the Related Art

A method is known in which, in the case where a terminal apparatus transmits a print job to an image forming apparatus, the image forming apparatus switches its operation state between an energy-saving state and a print-ready state based on time information included in the print job data (refer to, for example, Patent Document 1).

In Patent Document 1, however, the image forming apparatus only switches its operation state from the energy-saving state to the print-ready state based on the time information of a requested print time included in the print job data. Therefore, in Patent Document 1, the image forming apparatus cannot switch its operation state to the print-ready state based on the user's behavior such as, for example, going to the image forming apparatus to get the printed document at the time other than the requested print time.
[Patent Document 1] Japanese Patent Application Publication No. 2016-274575

### SUMMARY OF THE INVENTION

It is a general object of at least one embodiment of the present invention to control a power supply of an apparatus based on a user's action.

A power supply control apparatus according to the present embodiment includes a positional-information-obtaining unit configured to obtain positional information of a communication terminal; a process-information-obtaining unit configured to obtain process information requested by a user of the communication terminal; a distance-determination unit configured to, based on positional information of a processing apparatus that processes the process information obtained by the process-information-obtaining unit and the positional information of the communication terminal obtained by the positional-information-obtaining unit, calculate a distance between the processing apparatus and the communication terminal; and a power-supply-control unit configured to control a power supply of the processing apparatus based on the distance calculated by the distance-determination unit.

According to the present embodiment, it becomes possible for the user to control the power supply of the device the user uses based on the user's action.

### BRIEF DESCRIPTION OF THE DRAWINGS

Other objects and further features of embodiments will become apparent from the following detailed description when read in conjunction with the accompanying drawings.

FIG. 1 is a drawing illustrating an example of a configuration overview of a power supply control system.

FIG. 2 is a drawing illustrating an example of a hardware configuration of a client PC and a management server.

FIG. 3 is a drawing illustrating an example of a hardware configuration of the communication terminal.

FIG. 4 is a drawing illustrating an example of a hardware configuration of the image processing apparatus.

FIG. 5 is a drawing illustrating examples of functional blocks of apparatuses according to the first embodiment.

FIG. 6 is a flowchart illustrating the power supply control process according to the first embodiment.

FIG. 7 is a drawing illustrating examples of functional blocks of apparatuses according to the second embodiment.

FIG. 8 is a flowchart illustrating the power supply control process according to the second embodiment.

FIG. 9 is a drawing illustrating examples of functional blocks of apparatuses according to the third embodiment.

FIG. 10 is a flowchart illustrating the power supply control process according to the third embodiment.

FIGS. 11A and 11B are drawings illustrating state transitions of the image processing apparatus between an energy-saving state and a print-ready state.

### DESCRIPTION OF THE PREFERRED EMBODIMENTS

In the following, embodiments of the present invention will be described with reference to the accompanying drawings.

<An Example of a System: Configuration Overview>

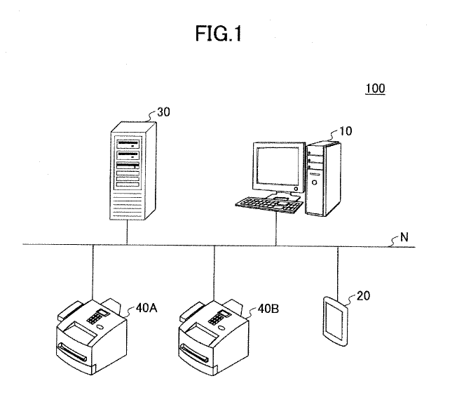

FIG. 1 is a drawing illustrating an example of a configuration overview of a power supply control system 100. As shown in FIG. 1, the power supply control system 100 includes a client PC (Personal Computer) 10, a communication terminal 20, a management server 30 as an example of a power supply control apparatus, and an image processing apparatus 40 (shown as apparatuses 40A and 40B in FIG. 1). These apparatuses are able to communicate with each other through, for example, a network N. The number of apparatuses are not limited to as shown in the figure.

The network N is, for example, the Internet, a WAN (Wide Area Network), a LAN (Local Area Network), or a combination of these. Note that the apparatuses may be connected to each other via an interface such as a connector.

The client PC 10 is a terminal that a user uses, and may be an information processing apparatus such as a smart phone or a PDA (Personal Digital Assistant). The client PC 10, when it receives a print request from the user, for example, issues a ticket to the communication terminal 20 that the user has and to the management server 30 through a printer driver. Also, the client PC 10 transmits print data corresponding to the ticket to the management server 30.

Here, in the ticket the client PC issues, included are user information and process information that specifies a process applied to the print data (for example, a print driver setting or print execution time). Note that the user information can include terminal information of the communication terminal 20 that the user has (for example, a physical address or an IP address). Also, the process information may include the print data.

The communication terminal 20 is a portable terminal that the user has in advance and may be a smart phone, a PDA, etc. The communication terminal 20 receives positioning information (positional information) via GPS (Global Positioning System) or IMES (Indoor Message System). Here, the communication terminal 20 may obtain the positional information by positioning technologies using, but not limited to, for example, Wi-Fi (Wireless Fidelity), ultrasonic waves, visible light communication, and autonomous navigation.

Regarding an implementation of the ON/OFF control of the communication terminal 20 for enabling the reception of the positional information, it is possible to cause the communication terminal 20 to set ON when it receives the ticket from the client PC and to set OFF when the ticket is deleted.

Also, the communication terminal 20, when it receives the ticket form the client PC, may, for example, transmit the ticket and the positional information to the management server 30.

The management server 30 manages information related to the image processing apparatus 40 that is connected to the network N in advance. Also, the management server 30 manages the ticket obtained from the client PC 10 or the communication terminal 20. It is preferable that the management server 30 may manage, as the information related to the image processing apparatus 40, for example, the IP address or the physical address of the image processing apparatus 40, the positional information of the location at which it is installed, the available driver information, etc.

Also, the management server 30, when it receives the ticket from the communication terminal 20, obtains the positional information of the communication terminal 20 that has sent the ticket and the positional information of the image processing apparatus 40 the management server 30 manages. Then, the management server 30, based on the obtained positional information of the communication terminal 20 and the image processing apparatus 40, determines whether the communication terminal 20 is within a predefined distance from the image processing apparatus 40. Then, the management server 30, in the case where it determines that the communication terminal 20 is within the predefined distance from the image processing apparatus 40, controls the power supply of the image processing apparatus 40 by transmitting a request to move the state of the power supply of the image processing apparatus 40 from the energy-saving state to the print-ready state.

Note that the management server 30 is described as performing the above processes using a single server. The management server 30 may perform the above processes using multiple servers, each of the servers being able to perform each of the processes.

The image processing apparatus 40 is, for example, an LP (Laser Printer), an MEP (Multifunction Peripheral), etc. In the case of the MFP, it includes, as image processing functions, a copy function, a scanning function, a print function, etc. The image processing apparatus 40, when it receives a request from the management server 30 to switch from the energy-saving state to the print-ready state, controls the power supply according to the request.

Note that, regarding the positional information of the image processing apparatus 40, the image processing apparatus 90 may include a reception unit for receiving the positional information and transmit it the management server 30. Also, the communication terminal 20, which is capable of receiving the positional information and includes a camera, may take an image of the image processing apparatus 40; calculate the positional information of the image processing apparatus 40 by using the positional information of the communication terminal 20, the direction at the time of taking the image of the image processing apparatus 40, and the distance to the image processing apparatus 40; and transmit the calculated positional information to the management server 30.

<Client PC 10 and Management Server 30: Hardware Configuration>

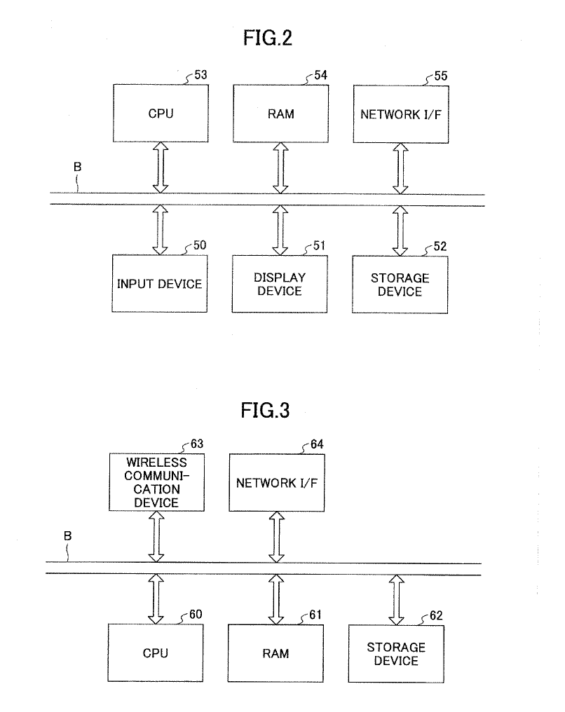

FIG. 2 is a drawing illustrating an example of a hardware configuration of the client PC 10 and the management server 30. As shown in FIG. 2, each of the client PC 10 and the management server 30 includes an input device 50, a display device 51, a storage device 52, a CPU (Central Processing Unit) 53, a RAM (Random Access Memory) 54 and a network I/F 55, which are connected to each other via a main bus B.

The input device 50 includes, for example, a keyboard or a mouse, and is used for inputting operation signals. The display device 51 includes, for example, a display, and displays processing results, etc., on the display.

The storage device 52 is, for example, an HDD (Hard Disk Drive) or an NVRAM (Non-Volatile Random Access Memory), and stores various programs and setting information.

The CPU 53 controls the apparatus as a whole. The RAM 54 provides a work area for the CPU 53. The network I/F 55 is an interface for communications with other apparatuses that are connected through the network N, etc.

By including the above hardware configuration, the client PC 10 and the management server 30 are capable of performing their functions.

<Communication Terminal 20 Hardware Configuration>

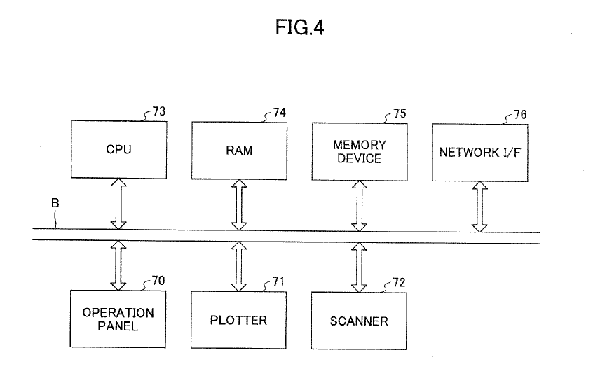

FIG. 3 is a drawing illustrating an example of a hardware configuration of the communication terminal 20. As shown in FIG. 3, the communication terminal 20 includes a CPU 60, a RAM 61, a storage device 62, a wireless communication device 63 and a network I/F 64 which are connected to each other via a main bus B.

The CPU 60 controls the apparatus as a whole. The RAM 61 provides a work area for the CPU 60. The storage device 62 is, for example, an HDD or an NVRAM, and stores various programs and setting information. The wireless communication device 63 includes an antenna which receives a positioning signal from such as GPS or IMES, and receives positional information included in the positioning signal. The network I/F 64 is an interface for communications with other apparatuses connected through the network N, etc.

Note that, in the case where the communication terminal 20 is an information processing apparatus such as a smart phone or a tablet, it may include a touch panel for receiving input from the user, input devices such as a keyboard or a mouse, a display device such as a display, etc.

By including the above hardware configuration, the communication terminal 20 is capable of performing its functions.

<Image Processing Apparatus 40 Hardware Configuration>

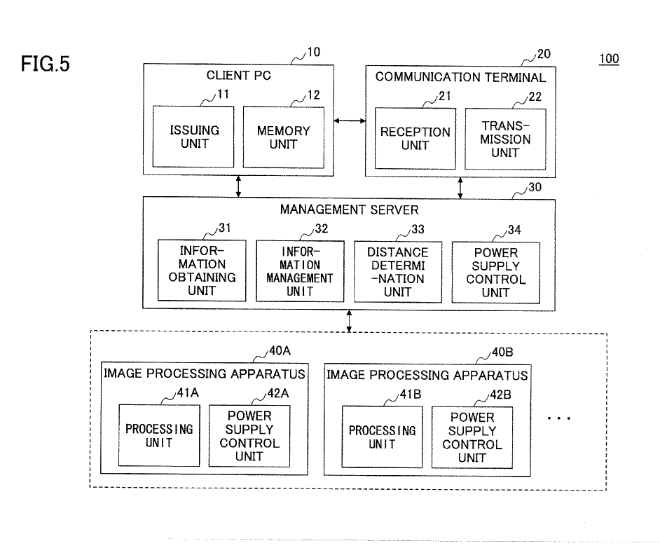

FIG. 4 is a drawing illustrating an example of a hardware configuration of the image processing apparatus 40. As shown in FIG. 4, the image processing apparatus 40 includes an operation panel 70, a plotter 71, a scanner 72, a CPU 73, a RAM 74, a memory device 75 and a network I/F 76 which are connected to each other via a main bus B.

The operation panel 70 includes input devices such as switches that the user operates, an LED display device, etc., and is used for inputting various setting information items and displaying various information items. The plotter 71 includes an image forming device and forms output images on sheets, etc. The scanner 72 optically reads images from an original document and generates image data.

The CPU 73 controls the apparatus as a whole. The RAM 74 provides a work area for the CPU 73. The memory device 75 is, for example, an HDD or an NVRAM, and stores control programs that the CPU 73 can execute and font data (including outline font data) that are used for displaying various kinds of information items. The network I/F 76 is an interface for communicating with other apparatuses that are connected via the network N, etc.

By including the above hardware configuration, the image processing apparatus 40 is capable of performs its functions.

<Power Supply Control System Functional Blocks>

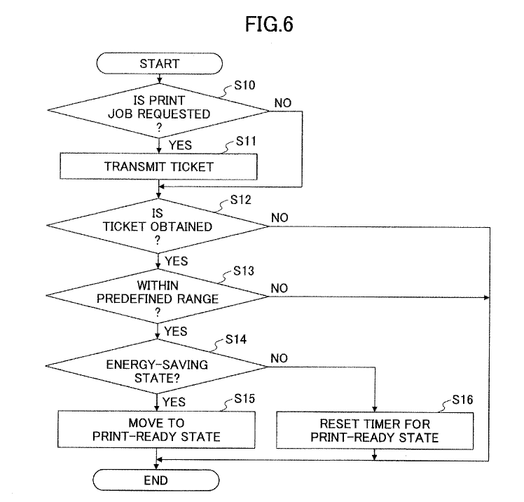

FIG. 5 is a drawing illustrating examples of functional blocks of apparatuses included in the power supply control system 100 according to the first embodiment. In the power supply control system 100, the client PC 10 includes an issuing unit 11 and a memory unit 12.

The issuing unit 11, for example, when receiving a print execution request from the user, issues a ticket via a print driver. The issuing unit 11 transmits the ticket to the communication terminal 20 and the management server 30. Note that the issuing unit 11 may also transmit print data to the management server 30 when it transmits the ticket.

The memory unit 12 stores terminal information (Physical address/IP address) of the communication terminal 20 that the user has in advance.

The communication terminal 20 includes a reception unit 21 and a transmission unit 22. The reception unit 21 receives its positional information through, for example, GPS or IMES, and receives the ticket transmitted by the client PC 10. The transmission unit 22 transmits the positional information together with the ticket to the management server 30.

The management server 30 includes an information obtaining unit 31, an information management unit 32 a distance determining unit 33 and a power-supply-control unit 34. The information obtaining unit 31 includes a function as a positional-information-obtaining unit for obtaining the positional information from the communication terminal 20 and a function as a processing information obtaining unit for obtaining the ticket from the client PC 10 or the communication terminal 20. Also, the information obtaining unit 31 obtains information of a state of the power supply from the image processing apparatus 40.

The information management unit 32 manages installation positional information of the image processing apparatus 40, the information of a state of the power supply of the image processing apparatus 40, the ticket obtained from the client PC 10 or the communication terminal 20, etc. Note that regarding the positional information of the image processing apparatus 40, the information may be used that is calculated by the communication terminal 20 that includes the above described digital camera capable of receiving positional information. The positional information can be calculated by an image of the image processing apparatus 40 being taken by the communication terminal 20, and using the positional information of the digital camera, the direction the digital camera faces, the distance to the image processing apparatus 40, etc., at the time when the image is taken. Here, the information defined in the image file format standard for digital still cameras, Exif, which is defined by Japan Electronics and Information Technology industries Association (JEITA), can be used.

The distance determining unit 33, when the ticket received from the client PC 10 and the ticket received from the communication terminal 20 are checked and confirmed to be the same, determines whether the distance between the image processing apparatus 40 and the communication terminal 20, which is managed by the information management unit 32, is within a predefined range. Here, the distance determining unit 33 may determine whether the distance between the communication terminal 20 and an image processing apparatus 40, which is capable of processing the processing information of the ticket, is within the predefined range. Note that the distance determining unit 33 is able to calculate the distance between the image processing apparatus 40 and the communication terminal 20 using the positional information of the image processing apparatus 40 and the positional information of the communication terminal 20, both of which are expressed in coordinates of longitude and latitude.

The power-supply-control unit 34, in the case where the distance between the image processing apparatus 40 and the communication terminal 20 is determined by the distance determining unit 33 to be within the predefined range, controls the power supply of the image processing apparatus 40 based on the information of the state of the power supply obtained from the image processing apparatus 40.

The power-supply-control unit 34, in the case where, for example, the state of the power supply of the image processing apparatus 40 is the print-ready state, requests to reset the timer for measuring the print-ready state maintaining time. The power-supply-control unit 34, in the case where the state of the power supply of the image processing apparatus 40 is the energy-saving state, requests to move to the print-ready state. In this way, the power-supply-control unit 34 is able to control the power supply based on the state of the power supply of the image processing apparatus 40.

Note that it is preferable that the management server 30 transmit the ticket and the print data obtained from the client PC 10 to the image processing apparatus 40 which controls the power supply by the power-supply-control unit 34.

The image processing apparatus 40 includes a processing unit 41 and a power-supply-control unit 42. Note that in an example shown in FIG. 5, multiple number of image processing apparatuses 40A, 40B, . . . , are connected to the network N, and include the same configuration, which will be described below.

The processing unit 41 performs a process for the print data based on the process information included in the ticket obtained from the management server 30. The power-supply-control unit 42 transmits the information of the state of the power supply to the management server 30, and controls the power supply based on the request obtained from the power-supply-control unit 34 of the management server 30.

By including the configuration described above, the behavior of the user who has requested a print job can be evaluated based on the positional information of the communication terminal 20 that the user has, and the power supply of the image processing apparatus 40 that is used for the print job can be controlled.

<Power Supply Control Process According to the First Embodiment>

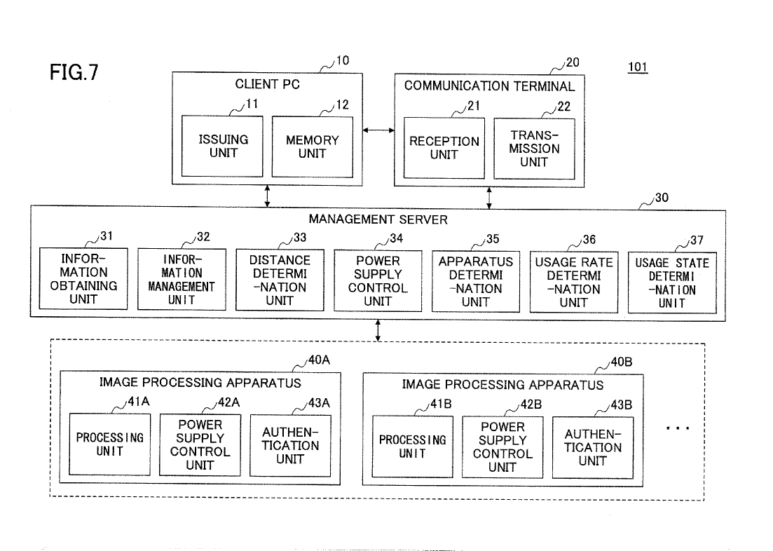

FIG. 6 is a flowchart illustrating the power supply control process according to the first embodiment. In an example shown in FIG. 6, it is assumed that multiple number of users use a single image processing apparatus 40.

As shown in FIG. 6, the client PC 10 determines whether a print job is requested by the user (S10). The client PC 10, when it is determined that the print job is requested (YES in S10), issues a ticket by using the issuing unit 11, and transmits the ticket to the communication terminal 20 and the management server 30 (S11). Note that when it is determined that the print job is not requested (No in S10), the flow moves to S12.

The communication terminal 20 determines whether the ticket transmitted by the client PC 10 is obtained (S12). When it is determined that the ticket is obtained (YES in S12), the communication terminal 20 transmits the ticket and its positional information to the management server 30. Note that it is preferable that, after determining that the ticket is obtained, the communication terminal 20 transmit the ticket and the positional information to the management server 30 periodically.

The management server 30, upon receiving tickets from both the client PC 10 and the communication terminal 20, comparing the two tickets, and determining that they are the same, determines whether the distance between the communication terminal 20 and the image processing apparatus 40, which is registered in the management server 30, is within a predefined range (S13). Here, the predefined range can be set by the user accordingly. For example, the predefined range may be a set fixed value, 2 m, and a transition time for the image processing apparatus 40 to move from the energy-saving state to the print-ready state (e.g., 5 s) may be calculated from the formula: (the predefined range)=(the user's speed(m/s)*(the transition time(s)).

Note that it is preferable that the management server 30 calculate the distance based on the positional information transmitted from the communication terminal 20 and the positional information of the image processing apparatus 40 stored in advance.

The management server 30, in the case where it determines that the distance between the communication terminal 20 and the image processing apparatus 40 is within the predefined range (YES in S13), determines whether the image processing apparatus 40 is in the energy-saving state (S14). Here, it is possible for the management server 30 to determine whether the image processing apparatus 40 is in the energy-saving state based on the information of the state of the power supply obtained from the image processing apparatus 40. Note that the image processing apparatus 40 may determine that it is in the print-ready state in the case where the power supply switch of the operation panel is ON, and that it is in the energy-saving state in the case where the power supply switch is OFF.

The management server 30, in the case where it determines that the image processing apparatus 40 is in the energy-saving state (YES in S14), transmits a request to the image processing apparatus 40 to move to the print-ready state (S15). Also, the management server 30, in the case where it determines that the image processing apparatus 40 is not in the energy-saving state (NO in S14), requests the image processing apparatus 40 to reset the timer for the print-ready state (S16), and ends its process.

Even in the case where the state of the power supply is controlled to move from the print-ready state to the energy-saving state when there is no operation, if the image processing apparatus 40 resets the timer that counts and stores the elapsed time of the print-ready state, then the power supply is controlled not to move to the energy-saving state during a user set time (e.g., 10 minutes).

Note that in the case where it is determined that a ticket is not obtained by the communication terminal 20 in the process of S12 (NO in S12), and in the case where it is determined that the distance between the communication terminal 20 and the image processing apparatus 40 is not within the predefined range (No in S13), the process ends.

### The Second Embodiment

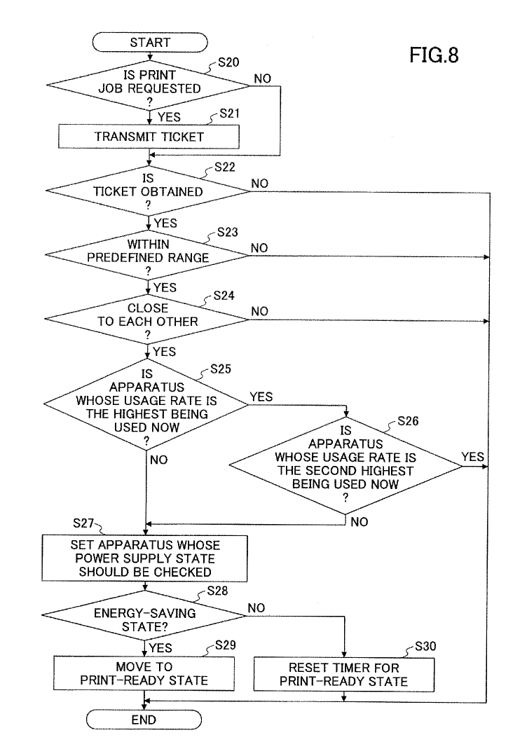

FIG. 7 is a drawing illustrating examples of functional blocks of apparatuses according to the second embodiment. The power supply control system 101 shown in FIG. 7 is different from the power supply control system 100 shown in FIG. 5 in that the management server 30 includes a apparatus-determination unit 35, a usage-rate-determination unit 36 and a usage-state-determination unit 37; and that the image processing apparatus 40 includes an authentication unit 43. In the following, the different points will be mainly described.

As shown in FIG. 7, the management server 30 includes the information obtaining unit 31, the information management unit 32, the distance-determination unit 33, the power-supply-control unit 34, the apparatus-determination unit 35, the usage-rate-determination unit 36 and the usage-state-determination unit 37.

The information management unit 32, when it obtains the user's authentication information and the information for identifying the image processing apparatus 40 (an IP address or a physical address) from the image processing apparatus 40, counts the number of times that each of the users has used the image processing apparatus 40 by using its counter function. Also, the information management unit 32 identifies, stores and manages the type of the printer driver installed in the client PC 10 that the user uses based on the printer driver setting information of the ticket received from the client PC 10, etc.

Note that it is preferable that the information management unit 32 store the terminal information of the communication terminal 20 that the user possesses in advance and the user's authentication information, the terminal information being associated with the user's authentication information. The user's authentication may be but is not limited to be, for example, a user ID and a password.

The distance-determination unit 33 may, when it determines that the distances between the communication terminal 20 and the multiple image processing apparatuses 40 registered by the information management unit 32 are within the predefined range, report the same to the apparatus-determination unit 35. Note that the distance-determination unit 33 may determine whether the distance between the communication terminal 20 and the image processing apparatus 40 of which the user's usage rate is determined to be the highest among the image processing apparatuses 40 located close to each other by the usage-rate-determination unit 36 is within the predefined range.

The apparatus-determination unit 35 determines whether there are image processing apparatuses 40 located close to each other among the multiple image processing apparatuses 40. For example, it is possible for the apparatus-determination unit 35 to determine that the image processing apparatuses 40 are close to each other when locations of the image processing apparatuses are determined to be within a predefined range (e.g., 3 m) based on the positional information of the image processing apparatuses 40.

Note that the apparatus-determination unit 35 may, in the case where it is reported by the distance-determination unit 33 that there are multiple image processing apparatuses 40 whose distances to the communication terminal 20 are within the predefined range, determine whether the multiple image processing apparatuses 40, whose distances are determined to be within the predefined range, are close to each other.

The usage-rate-determination unit 36 calculates the user's usage rate for each of the image processing apparatuses 40 based on the type of the printer driver installed in the client PC 10 of the user and the number of times the user has actually used each of the image processing apparatuses 40, both of which are managed by the information management unit 32.

The usage-state-determination unit 37 determines, based on the information obtained by the user authentication of the image processing apparatus 40 that identifies the image processing apparatus the user uses (IP address, physical address, etc.,) whether the image processing apparatus 40 is being used now. The usage-state-determination unit 37 determines whether, for example, the image processing apparatus, whose usage rate by the user is determined to be the highest by the usage-rate-determination unit 36, is being used now.

The image processing apparatus 40 includes the processing unit 41, the power-supply-control unit 42 and the authentication unit 43. The authentication unit 43 performs the user authentication by using a user ID and a password input in an input screen such as an operation panel. Note that the authentication may be, but is not limited to be, performed by using a card with a built-in ID chip that identifies the user.

The authentication unit 43, when the user authentication is completed, transmits to the management server 30 the user authentication information and the information that identifies the image processing apparatus 40 the user has used in the authentication (IP address, physical address, etc.) By this, it becomes possible for the management server 30 to obtain information indicating whether the image processing apparatus 40 is being used now.

<Power Supply Control Process According to the Second Embodiments>

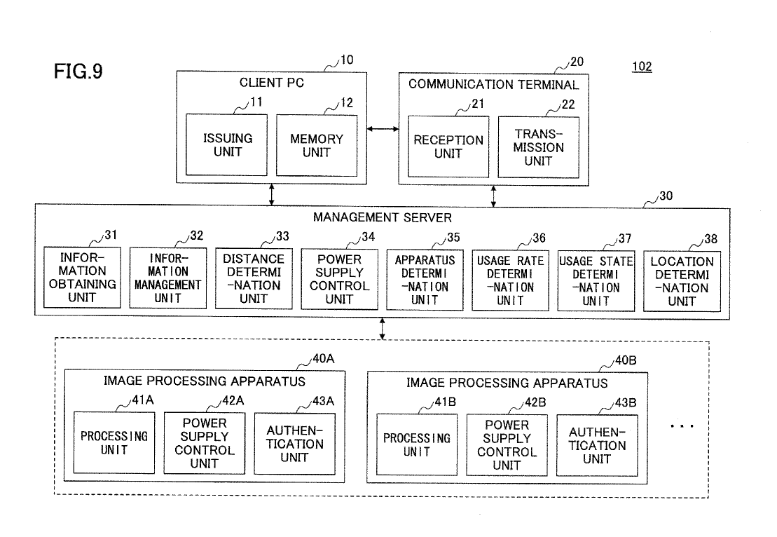

FIG. 8 is a flowchart illustrating the power supply control process according to the second embodiment. In an example shown in FIG. 8, a case is assumed in which multiple image processing apparatuses 40 are used by multiple users. In FIG. 8, an example is shown in which there are two image processing apparatuses 40. There may be three or more image processing apparatuses 40.

Note that because processes of S20 through S23 shown in FIG. 8 are the same as those of S10 through S13 in FIG. 6, the description will be omitted.

In the process of S23, in the case where the management server 30 determines that distances between the communication terminal 20 and multiple registered image processing apparatuses 40 are within the predefined range (YES in S23), it determines whether the multiple image processing apparatuses 40 are close to each other (S24). Here, regarding “close to each other”, it is possible to determine that the multiple image processing apparatuses 40 are close to each other in the case where they are located within a predefined range (e.g., 3 m) from each other. Note that it is not necessary to limit the predefined range to be 3 m.

The management server 30, when it determines that the multiple image processing apparatuses 40 are close to each other (YES in S24), determines whether the image processing apparatus 40, of which the user usage rate is the highest, is being used now (S25). Here, because the management server 30 counts and stores information of the number of usage times of the image processing apparatus 40 by the user, it is preferable that the management server 30 calculate the usage rate by using the information.

Also, because of the user authentication of the image processing apparatus 40, information that identifies the image processing apparatus 40 the user has used is transmitted to the management server 30. It becomes possible for the management server 30 to determine whether that image processing apparatus 40 is being used now based on the information.

The management server 30, in the case where it determines that the image processing apparatus 40 of which the user usage rate is the highest is being used now (YES in S25), determines whether the image processing apparatus 40 of which the user usage rate is the second highest is being used now (S26). Note that, in the processes in FIG. 8, in the case where more than three image processing apparatuses 40 are used, the process of S26 may be repeated for a number of times equal to the number of the image processing apparatuses 40.

The management server 30, in the case where it determines that the image processing apparatus 40 of which the user usage rate is the second highest is not being used now (NO in S26), sets that image processing apparatus 40 as an apparatus whose power supply state should be checked (S27) and the process moves to S28.

Note that in the process of S24, in the case where it is determined that the registered image processing apparatuses 40 are not close to each other (NO in S24), or in the process of S26, in the case where it is determined that the image processing apparatus 40, whose usage rate is the second highest, is being used now (YES in S26), the process ends.

As described above, even in the case where there are multiple image processing apparatuses 40 which are close to each other, it becomes possible to identify the apparatus to which the power supply control should be preferentially applied based on the user usage rate or the current usage state.

### The Third Embodiment

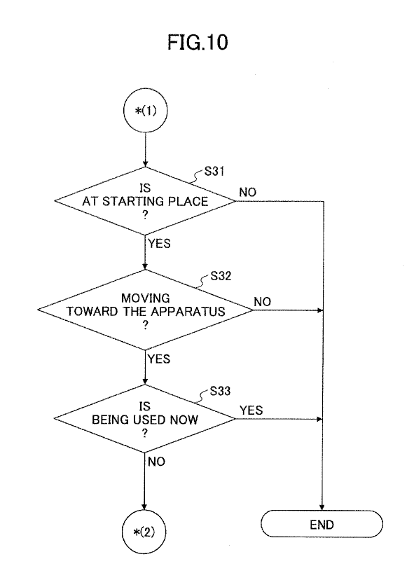

FIG. 9 is a drawing illustrating examples of functional blocks of apparatuses according to the third embodiment. The power supply control system 102 shown in FIG. 9 is different from the power supply control system 101 shown in FIG. 7 in that the management server 30 includes a location-determination unit 38. In the following, the different points will be mainly described.

As shown in FIG. 9, the management server 30 includes the information obtaining unit 31, the information management unit 32, the distance-determination unit 33, the power-supply-control unit 34, the apparatus-determination unit 35, the usage-rate-determination unit 36, the usage-state-determination unit 37 and the location-determination unit 38.

The information management unit 32 stores and manages a starting place of a route set in advance for each of the users. Here, regarding the starting place of the route, a place where the user's desk is located, an entrance/exit of the user's room, a meeting room, etc., can be set and stored.

The distance-determination unit 33, in the case where it is determined by the location-determination unit 38 that the user is at the starting place of the route, determines the distance between the communication terminal 20 and the image processing apparatus 40 based on the positional information of the communication terminal 20 and the positional information of the image processing apparatus 40. In the case where it is determined, for example, that the distance between the communication terminal 20 and the image processing apparatus 40 is continuously decreasing, the distance-determination unit 33 determines that the communication terminal 20 is moving toward the image processing apparatus 40.

The location-determination unit 38, in the case where the information obtaining unit 31 obtains a ticket from the communication terminal 20, determines whether the user is at (or reaches) the starting place of the route, which is set in advance, stored and managed for each of the users. Here, the location-determination unit 38 determines that the user is at the starting place of the route when it is determined that, taking measurement errors into account, the location of the communication terminal 20 is within a predefined range from the location of the starting place based on the positional information obtained from the communication terminal 20 and the location information of the starting place of the route set in advance.

In the case described above and only in this case, it is determined that the user, whose ticket is obtained, has an intention to print and it becomes possible for the power supply of the image processing apparatus 40 to be controlled.

<Power Supply Control Process According to the Third Embodiment>

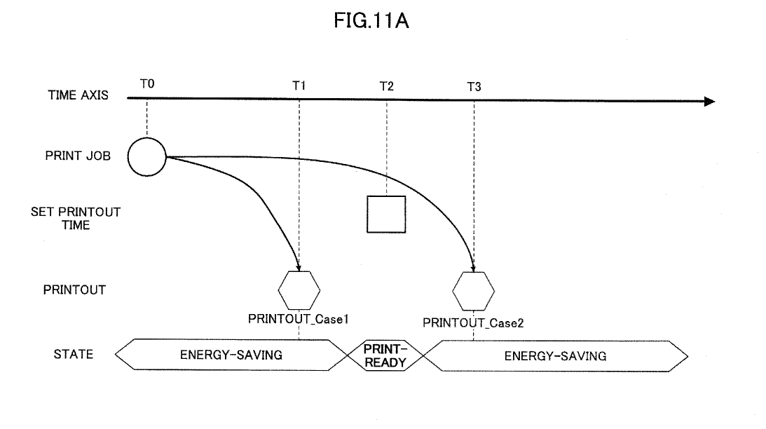

FIG. 10 is a flowchart illustrating the power supply control process according to the third embodiment. Note that FIG. 10 shows an example process for solving a problem, in which the state of the power supply of the image processing apparatus 40 is moved from the energy-saving state to the print-ready state in the case where the ticket is obtained and the user with no intention of receiving an immediate printout is near the image processing apparatus 40.

A *(1) in FIG. 10 indicates the process of S12 shown in FIG. 6. A *(2) in FIG. 10 indicates the process of S13 shown in FIG. 6. In other words, in the process of S12, in the case where it is determined that the ticket is obtained by the communication terminal 20 (YES in S12), the management server 30 determines whether the user is at the starting place of the route the user set in advance (S31).

The management server 30, in the case where it is determined that the user is at the starting place of the route (YES in S31), determines whether the user is moving toward the image processing apparatus 40 (S32). Regarding the determination whether the user is moving toward the image processing apparatus 40, it is possible to determine that the user is moving toward the image processing apparatus 40 when it is determined that the distance between the communication terminal 20 of the user and the image processing apparatus 40 is continuously decreasing.

The management server 30, in the case where it is determined that the user is moving toward the image processing apparatus 40 (YES in S32), determines whether the image processing apparatus 40 is being used now (S33). Note that it is possible to make a determination whether the image processing apparatus 40 is being used now in the same way as in the processes of S25 and S26 in FIG. 8.

The management server 30, in the case where it is determined that the image processing apparatus is not being used now (NO in S33), move to the process of S13 and determines whether the distance to the image processing apparatus 40 is within a predefined range.

Note that in the case where it is determined that the user is not at the starting place of the route (NO in S31), in the case where it is determined that the user is not moving toward the image processing apparatus 40 (NO in S32), or in the case where it is determined that the image processing apparatus 40 is being used now (YES in S33), the process ends.

Regarding the determination that the user has an intention of receiving the printout, it is determined based on the processes S31 through S33 above. It is not necessary to use all of the processes above. It may be possible to introduce different determination criteria.

<State Transition to the Print-Ready State>

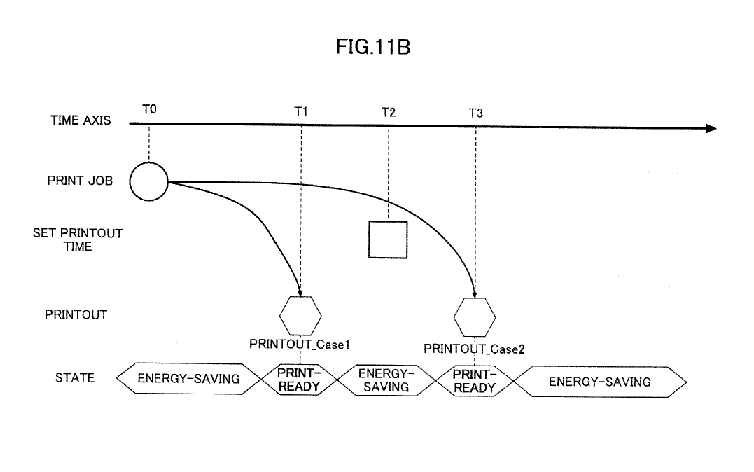

FIGS. 11A and 11B are drawings illustrating state transitions of the image processing apparatus between an energy-saving state and a print-ready state. FIG. 11A is a drawing illustrating a conventional state transition to the print-ready state. FIG. 11B is a drawing illustrating a state transition to the print-ready state according to the present embodiment.

As shown in FIG. 11A, let the time when print job is performed by the printer driver be T0; described will be the time T1 when the user performs the printout before the printout time set by the user, the printout time T2 set by the user, and the time T3 when the user performs the printout after the printout time.

Conventionally, during the time T0 through T3, the state becomes the print-ready state only at the printout time T2 set by the user, and the state becomes the energy-saving state at the time T1 which is before the time T2 and at the time T3 which is after the time T2. As a result, the user has to wait in front of the image processing apparatus 40 for the image processing apparatus 40 to move to the print-ready state.

On the other hand, as shown in FIG. 11B, in the above first, second and third embodiments, in the case where the distance between the user and the image processing apparatus 40 is within the predefined range, the state moves from the energy-saving state to the print-ready state. As a result, the waiting time described above using FIG. 11A can be removed.

As described above, according to the present embodiment, it becomes possible to control the power supply of the apparatus that the user uses based on the user behavior.

Further, the present invention is not limited to these embodiments, and various variations and modifications may be made without departing from the scope of the present invention.

The present application is based on and claims the benefit of priority of Japanese Priority Application No. 2013-027729 filed on Feb. 15, 2013, with the Japanese Patent Office, the entire contents of which are hereby incorporated by reference.

What is claimed is:

1. A power supply control apparatus comprising:
a positional-information-obtaining unit configured to obtain positional information of a communication terminal;
a process-information-obtaining unit configured to obtain process information requested by a user of the communication terminal;
a distance-determination unit configured to, based on positional information of a processing apparatus that processes the process information obtained by the process-information-obtaining unit and the positional information of the communication terminal obtained by the positional-information-obtaining unit, calculate a distance between the processing apparatus and the communication terminal; and
a power-supply-control unit configured to control a power supply of the processing apparatus based on the distance calculated by the distance-determination unit.

2. The power supply control apparatus as claimed in claim 1, further comprising:
an apparatus-determination unit configured to determine whether a plurality of said processing apparatuses are close to each other; and
a usage-rate-determination unit configured to calculate a usage rate of each of the plurality of said processing apparatuses by the user, wherein the distance-determination unit calculates a distance between the communication terminal and one of said processing apparatuses whose usage rate by the user is calculated to be a highest among the plurality of said processing apparatuses which are determined by the apparatus-determination unit to be close to each other.

3. The power supply control apparatus as claimed in claim 1, further comprising a location-determination unit configured to determine whether the communication terminal reaches a place set for the user, wherein the distance-determination unit, the case where it is determined that the communication terminal has reached the place set for the user, calculates the distance between the processing apparatus and the communication terminal.

4. The power supply control apparatus as claimed in claim 1, wherein the distance-determination unit determines whether the communication terminal is moving toward the processing apparatus.

5. The power supply control apparatus as claimed in claim 1, further comprising a usage-state-determination unit configured to determine whether the processing apparatus is being used now, wherein the distance-determination unit calculates the distance between the communication terminal and the processing apparatus that is determined to not be in use now by the usage-state-determination unit.

6. The power supply control apparatus as claimed in claim 1, wherein the power-supply-control unit controls the power supply of the processing apparatus in accordance with the state of the power supply of the processing apparatus.

7. The power supply control apparatus as claimed in claim 6, wherein the power-supply-control unit, in the case where the state of the power supply of the processing apparatus is a print-ready state, requests to reset a timer for measuring the print-ready state maintaining time, and, in the case where the state of the power supply is an energy-saving state, causes the processing apparatus to move to the print-ready state.

8. A power supply control system comprising:
a communication terminal,
a processing apparatus that processes process information requested by a user of the communication terminal, and
a power supply control apparatus that controls a power supply of the processing apparatus,
the power supply control apparatus including:
a positional-information-obtaining unit configured to obtain positional information of the communication terminal;
a process-information-obtaining unit configured to obtain the process information requested by the user of the communication terminal;
a distance-determination unit configured to, based on positional information of the processing apparatus that processes the process information obtained by the process-information-obtaining unit and the positional information of the communication terminal obtained by the positional-information-obtaining unit, calculate a distance between the processing apparatus and the communication terminal; and
a power-supply-control unit configured to control the power supply of the processing apparatus based on the distance calculated by the distance-determination unit.

9. A power supply control method in a power supply control system including a communication terminal, a processing apparatus that processes process information requested by a user of the communication terminal, and a power supply control apparatus that controls a power supply of the processing apparatus, the power supply control method comprising:
a positional-information-obtaining step of obtaining positional information of the communication terminal;
a process-information-obtaining step of obtaining the process information requested by the user of the communication terminal;
a distance-determination step of, based on positional information of the processing apparatus that processes the process information obtained in the process-information-obtaining step and the positional information of the communication terminal obtained in the positional-information-obtaining step, calculating a distance between the processing apparatus and the communication terminal; and
a power-supply-control step of, based on the distance calculated in the distance-determination step, controlling the power supply of the processing apparatus.
